(19) United States
(12) Patent Application Publication
(10) Pub. No.: US 2020/0169714 A1
(43) Pub. Date: May 28, 2020

(54) 3D VISUAL INTELLIGENT SIMULATION MONITORING SYSTEM AND SIMULATION DISPLAY METHOD THEREOF

(71) Applicants: Syuan-Pei Chang, Taipei (TW); Wei-Yu Chen, Taipei (TW)

(72) Inventors: Syuan-Pei Chang, Taipei (TW); Wei-Yu Chen, Taipei (TW)

(21) Appl. No.: 16/199,482

(22) Filed: Nov. 26, 2018

(51) Int. Cl. H04N 13/122; H04N 13/279; H04N 7/18; G06K 9/00; G06K 9/46; H04W 4/029

(52) U.S. Cl. CPC H04N 13/122; H04N 13/279; H04W 4/029; G06K 9/00771; G06K 9/4638; H04N 7/181

(57) ABSTRACT

The present invention provides a 3D visual intelligent simulation monitoring system and a simulation display method thereof, comprising a plurality of monitoring devices and at least one central control device. The monitoring devices capture video screens and generate a plurality of image signals to the central control device. A signal receiving unit of the central control device receives the image signals of the monitoring devices and transmits to an operational simulation unit, and the operational simulation unit operates the image signals with a location data and a geographic data incorporatively and generates at least one 3D simulation image. Thereby monitoring personnel can directly monitor with the 3D simulation image of the central control device, thus achieving comprehensive viewing and perfect monitoring, and functions of responding and manipulating at the first instant through the central control device.

### BACKGROUND OF THE INVENTION

### Field of Invention

The present invention relates to a 3D visual intelligent simulation monitoring system and a simulation display method thereof which can view comprehensively and monitor perfectly and one can response and manipulate at the first instant.

### Related Art

As labor costs continue to increase, more companies tend to use surveillance systems for security work, in order to achieve the most comprehensive protection under limited human resources. With the development of technology, surveillance and video recording devices such as digital video recorders (DVR), network video recorders (NVR), and the like, have been widely used for security and property protection of personal and public environment. In addition, common video surveillance systems are usually equipped with multiple image capturing devices, and can achieve a purpose of simultaneously monitoring multiple locations (such as lobby doors, parking lots, etc.) by using the method of displaying the images captured by each of the image capturing devices on a display screen simultaneously or in a time-sharing manner. Surveillance and video recording devices are installed in stores, POS terminals, shops, parking lots, distribution centers, warehouses and/or private office spaces for using as preventive and suppressive measures for illegal activities such as burglary, illegal intrusion, damage to buildings, etc. However, general surveillance and video recording systems can only view the images captured by each surveillance device and adjust the distance of the video screens, but if the surveillance system is to be set up in a large area, a considerable amount of surveillance devices is required. However, it will be relatively inconvenient for monitoring personnel to monitor on the screens, and cannot view comprehensively and monitor perfectly. Moreover, it is difficult for the monitoring personnel to correctly evaluate the precise position of an object or a human body on the screens, not to mention that the object or the human body will move its position in a wide area, thereby causing it to move between different surveillance devices. The monitoring personnel need to evaluate and guess according to different surveillance devices, and can not perform corresponding response and screen manipulation at the first instant.

Therefore, how to solve and improve the above problems and deficiencies in the prior art, is the area the inventor of the present invention and the relevant manufacturers engaged in this industry want to work on earnestly.

### SUMMARY OF THE INVENTION

Accordingly, in order to effectively solve the above problems, a main object of the present invention is to provide a 3D visual intelligent simulation monitoring system that can view comprehensively and monitor perfectly and one can response and manipulate at the first instant.

In order to achieve the above object, the present invention provides a 3D visual intelligent simulation monitoring system, which comprises a plurality of monitoring devices and at least one central control device, wherein the monitoring devices are disposed at positions of a to-be-monitored area, and the monitoring devices capture video screens of the to-be-monitored area and generate a plurality of image signals. The central control device connects the monitoring devices in a wireless or wired manner, and the central control device has a signal receiving unit and an operational simulation unit. The signal receiving unit receives the image signals of the monitoring devices, and the signal receiving unit transmits the image signals to the operational simulation unit. Inside the central control device is further stored with at least one location data and at least one geographic data. The operational simulation unit operates the image signals with the location data and the geographic data incorporatively and generates at least one 3D simulation image, and the 3D simulation image generated by the operational simulation unit is presented in the central control device. Thereby monitoring personnel can directly monitor with the 3D simulation image of the central control device, thus achieving comprehensive viewing and perfect monitoring, and functions of responding and manipulating at the first instant through the central control device.

The present invention further provides a 3D visual intelligent simulation display method, the method comprising steps of: providing a plurality of monitoring devices for capturing video screens of a to-be-monitored area and generating a plurality of image signals; receiving the image signals of the monitoring devices by a central control device and aggregating the image signals thereof by an operational simulation unit; the central control device storing at least one location data and at least one geographic data, and the operational simulation unit first compressing the location data and the geographic data and then analyzing with the aggregated image signals and generating at least one 3D simulation image. Thereby, the 3D simulation image is presented in the central control device, and monitoring personnel can directly monitor with the 3D simulation image of the central control device, thus achieving comprehensive viewing and perfect monitoring, and functions of responding and manipulating at the first instant through the central control device.

### BRIEF DESCRIPTION OF THE DRAWINGS

FIG. 1 is a block diagram of a 3D visual intelligent simulation monitoring system of the present invention;

FIG. 2 is a schematic block diagram 1 of the 3D visual intelligent simulation monitoring system of the present invention;

FIG. 3 is a schematic block diagram 2 of the 3D visual intelligent simulation monitoring system of the present invention;

FIG. 4 is a flow chart 1 of a 3D visual intelligent simulation display method of the present invention; and

FIG. 5 is a flow chart 2 of the 3D visual intelligent simulation display method of the present invention.

### DETAILED DESCRIPTION OF THE INVENTION

The foregoing and other technical contents, features and effects of the present invention will be clearly presented in the following detailed description of the preferred embodiment with reference to the drawings.

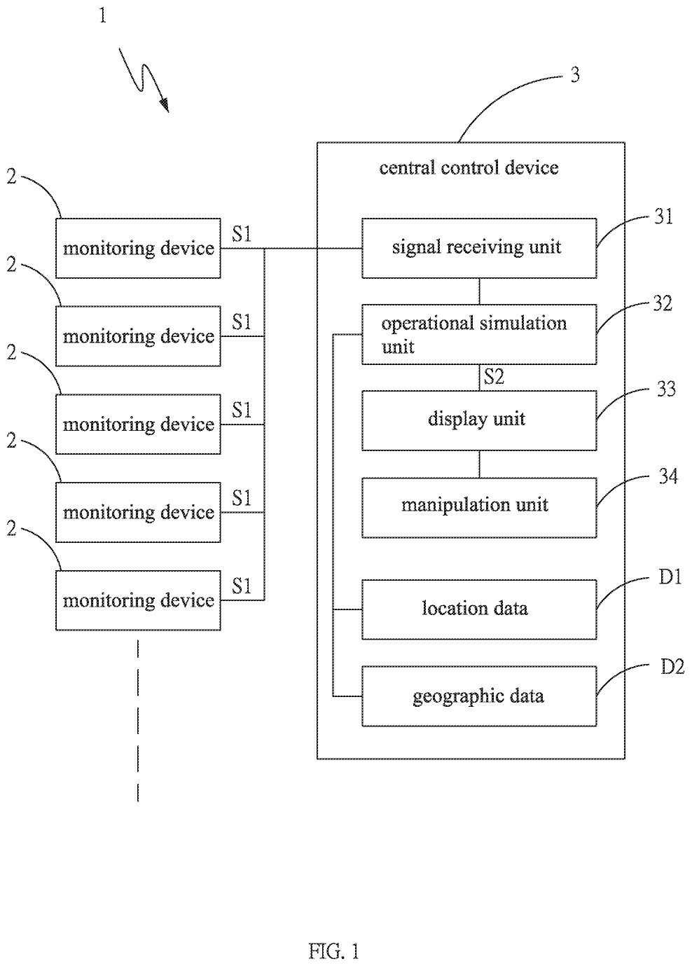

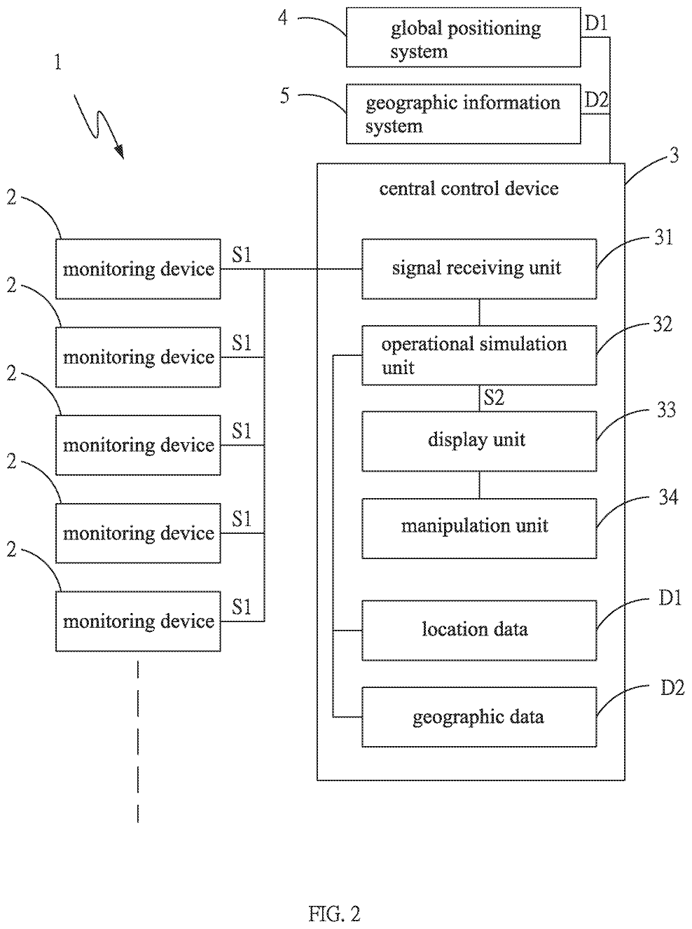

Please refer to FIG. 1 to FIG. 2, which are respectively block diagram of a 3D visual intelligent simulation monitoring system of the present invention, and schematic block diagram 1 of the 3D visual intelligent simulation monitoring system of the present invention. It can be clearly seen from the figures that a monitoring system 1 comprises a plurality of monitoring devices 2 and at least one central control device 3, wherein the monitoring system 1 monitors a to-be-monitored area, the monitoring devices 2 are disposed at positions of the to-be-monitored area, the monitoring devices 2 are connected to the central control device 3, and the monitoring devices 2 are connected to the central control device 3 in a wireless or wired manner. The monitoring devices 2 capture video screens of the to-be-monitored area and generate a plurality of image signals S1. The central control device 3 has a signal receiving unit 31, an operational simulation unit 32, a display unit 33 and at least one manipulation unit 34, wherein the signal receiving unit 31 receives the image signals S1 of the monitoring devices 2, and the signal receiving unit 31 simultaneously transmits the received image signals S1 to the operational simulation unit 32. Inside the central control device 3 is stored with at least one location data D1 and at least one geographic data D2. The operational simulation unit 32 operates the image signals S1 with the location data D1 and the geographic data D2 incorporatively and generates at least one 3D simulation image S2, and the operational simulation unit 32 presents the 3D simulation image S2 on the display unit 33. The manipulation unit 34 controls a presented angle orientation and a presentation distance of the 3D simulation image S2 displayed on the display unit 33.

In addition, the central control device 3 of the monitoring system 1 is electrically connected to a global positioning system (GPS) 4, and the central control device 3 is also electrically connected to a geographic information system (GIS) 5 simultaneously. Inside the global positioning system 4 is stored with the plurality of location data D1, and the central control device 3 receives the location data D1 via the signal receiving unit 31 and stores the information. Inside the geographic information system 5 is stored with the plurality of geographic data D2, and the central control device 3 receives the geographic data D2 via the signal receiving unit 31 simultaneously and stores the information. The location data D1 and the geographic data D2 received by the signal receiving unit 31 are stored in the central control device 3 and transmitted to the operational simulation unit 32. The operational simulation unit 32 operates the image signals S1 with the location data D1 and the geographic data D2 incorporatively and generates the 3D simulation image S2. Thereby monitoring personnel can directly monitor with the 3D simulation image S2 of the central control device 3, thus achieving comprehensive viewing and perfect monitoring, and functions of responding and manipulating at the first instant through the central control device 3.

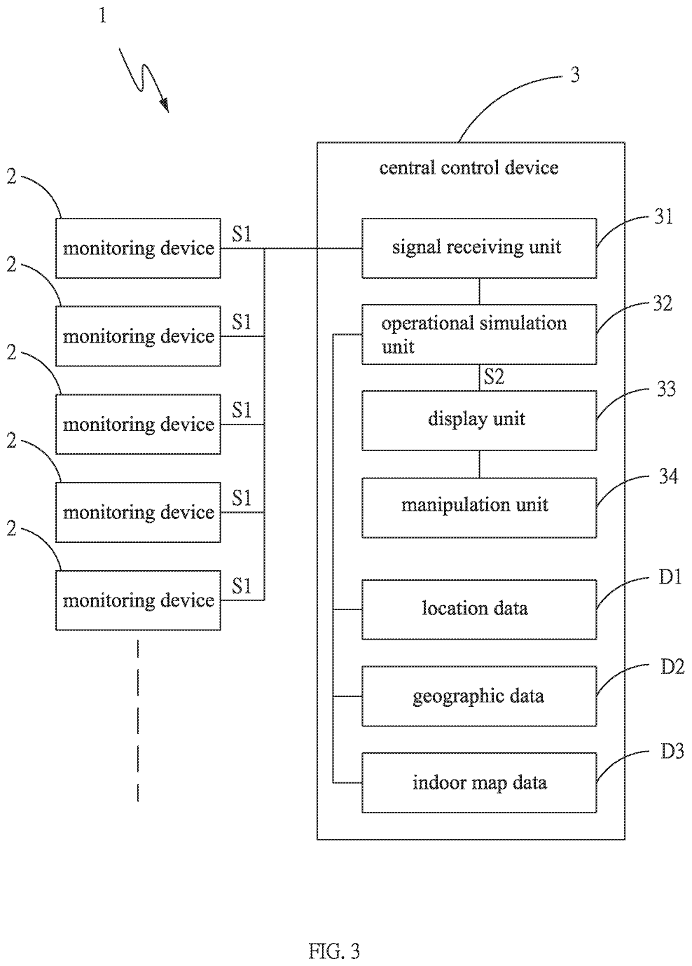

Please refer to FIG. 3 again, which is the schematic block diagram 2 of the 3D visual intelligent simulation monitoring system of the present invention. It can be clearly seen from the figure that, the central control device 3 further stores at least one indoor map data D3, and the monitoring system 1 performs indoor monitoring for a to-be-monitored area, and the monitoring devices 2 are disposed at indoor positions of the to-be-monitored area. The monitoring devices 2 are connected to the central control unit 3. The monitoring devices 2 capture video screens of the to-be-monitored area and generate the image signals S1, and the image signals S1 are transmitted to the operational simulation unit 32. The operational simulation unit 32 operates the image signals S1 with the location data D1, the geographic data D2 and the indoor map data D3 incorporatively and generates the 3D simulation image S2. The 3D simulation image S2 can present its indoor simulation image through the indoor map data D3. The operational simulation unit 32 presents the 3D simulation image S2 on the display unit 33. The manipulation unit 34 controls a presented angle orientation and a presentation distance of the 3D simulation image S2 displayed on the display unit 33. Thereby monitoring personnel can directly monitor with the 3D simulation image S2 of the central control device 3, thus achieving comprehensive viewing and perfect monitoring, and functions of responding and manipulating at the first instant through the central control device 3.

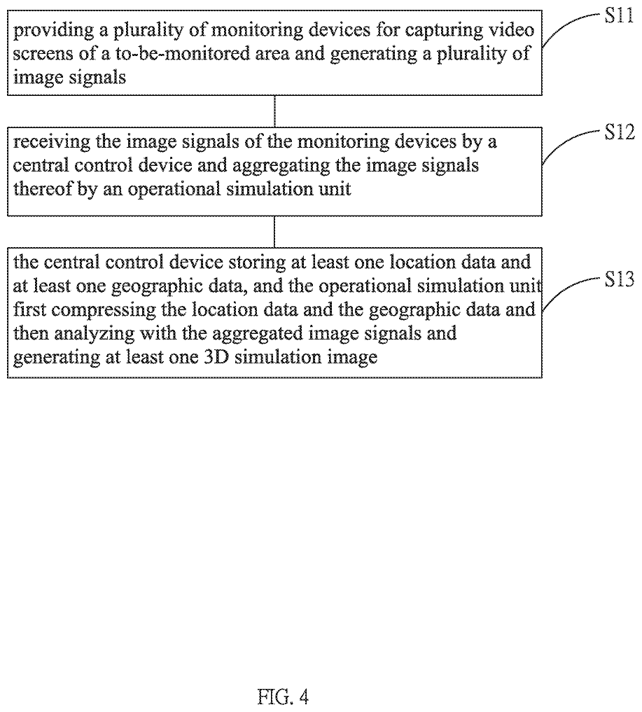

In addition, as shown in the foregoing drawings, and FIG. 4, which is a flow chart 1 of a 3D visual intelligent simulation display method of the present invention. It can be clearly seen from the figure that, the 3D visual intelligent simulation display method comprises the following steps.

Step S11: Providing a plurality of monitoring devices for capturing video screens of a to-be-monitored area and generating a plurality of image signals. Wherein a plurality of monitoring devices 2 is provided, the monitoring devices 2 are disposed at positions of the to-be-monitored area, and each of the monitoring devices 2 respectively captures a video screen of the to-be-monitored area and respectively generates an image signal S1.

Step S12: Receiving the image signals of the monitoring devices by a central control device and aggregating the image signals thereof by an operational simulation unit. A central control device 3 is provided, the central control device 3 is connected to the monitoring devices 2, and the monitoring devices 2 are connected to the central control device 3 in a wireless or wired manner. The central control device 3 has a signal receiving unit 31 and an operational simulation unit 32. The signal receiving unit 31 receives the image signals S1 and transmits the image signals S1 to the operational simulation unit 32. The operational simulation unit 32 aggregates the image signals S1 of all the monitoring devices 2, wherein the operational simulation unit 32 first automatically stitches overlapping parts of the images and then aggregates the image signals S1 thereof.

Step S13: The central control device storing at least one location data and at least one geographic data, and the operational simulation unit first compressing the location data and the geographic data and then analyzing with the aggregated image signals and generating at least one 3D simulation image. Wherein inside the central control device 3 is further stored with the location data D1 and the geographic data D2. The central control device 3 is electrically connected to the global positioning system (GPS) 4 and receives at least one of the location data D1 of the global positioning system. The central control device 3 is also electrically connected to the geographic information system (GIS) 5 and receives at least one of the geographic data D2 of the geographic information system. The operational simulation unit 32 first receives the location data D1 and the geographic data D2 and then compresses the data, and analyzes the compressed image files with the aggregated image signals S1. The operational simulation unit 32 generates the 3D simulation image after the analysis, and the 3D simulation image at this stage can be adjusted with a 3D model. Afterwards, the 3D simulation image is displayed by the central control device 3, and the central control device 3 further has the display unit 33 and the manipulation unit 34. The operational simulation unit 32 presents the 3D simulation image S2 on the display unit 33, and the manipulation unit 34 controls a presented angle orientation and a presentation distance of the 3D simulation image S2 displayed on the display unit 33.

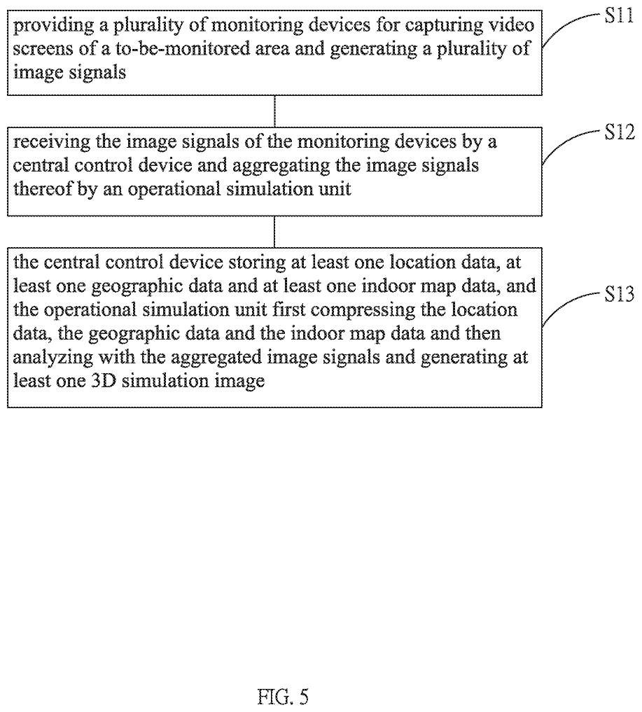

Please refer to the aforementioned drawings and FIG. 5 as well, which is a flow chart 2 of the 3D visual intelligent simulation display method of the present invention. It can be clearly seen from the figure that the step S13 of the 3D visual intelligent simulation display method can further be: the central control device storing at least one location data, at least one geographic data and at least one indoor map data, the operational simulation unit first compressing the location data, the geographic data and the indoor map data, and then analyzing with the aggregated image signals and generating at least one 3D simulation image. Inside the central control device 3 is further stored with the location data D1 and the geographic data D2. The central control device 3 is electrically connected to the global positioning system (GPS) 4 and receives at least one of the location data D1 of the global positioning system. The central control device 3 is also electrically connected to the geographic information system (GIS) 5 and receives at least one of the geographic data D2 of the geographic information system. The central control device 3 further receives the indoor map data D3. The operational simulation unit 32 operates the image signals S1 with the location data D1, the geographic data D2 and the indoor map data D3 incorporatively and generates the 3D simulation image S2. The 3D simulation image S2 can present its indoor simulation image through the indoor map data D3. The operational simulation unit 32 presents the 3D simulation image S2 on the display unit 33. The manipulation unit 34 controls a presented angle orientation and a presentation distance of the 3D simulation image S2 displayed on the display unit 33. Thereby monitoring personnel can directly monitor with the 3D simulation image S2 of the central control device 3, thus achieving comprehensive viewing and perfect monitoring, and functions of responding and manipulating at the first instant through the central control device 3.

It is to be understood that the above description is only a preferred embodiment of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

1. A 3D visual intelligent simulation monitoring system, comprising:
a plurality of monitoring devices, the monitoring devices capturing video screens of a to-be-monitored area and generating a plurality of image signals; and
at least one central control device for storing at least one location data and at least one geographic data and connecting the monitoring devices; the central control device comprising:
a signal receiving unit for receiving and transmitting the image signals;
an operational simulation unit for receiving the image signals which is transmitted from the signal receiving unit, and generating at least one 3D simulation image by operating the received image signals with the location data and the geographic data, wherein the at least one 3D simulation image is to be displayed by the central control device; and
at least one manipulation unit for controlling a presented angle orientation and a presentation distance of the 3D simulation image.

2. The 3D visual intelligent simulation monitoring system as claimed in claim 1, wherein the central control device further has at least one display unit, and the display unit can display the 3D simulation image.

3. (canceled)

4. The 3D visual intelligent simulation monitoring system as claimed in claim 1, wherein the central control device is electrically connected to a global positioning system (GPS) and receives at least one of location data of the global positioning system, and the central control device is also electrically connected to a geographic information system (GIS) and receives at least one of geographic data of the geographic information system.

5. The 3D visual intelligent simulation monitoring system as claimed in claim 2, wherein the central control device further stores at least one indoor map data, and the operational simulation unit operates the image signals with the location data, the geographic data and the indoor map data and generates the at least one 3D simulation image to be displayed by the display unit.

6. A 3D visual intelligent simulation display method, comprising steps of:
providing a plurality of monitoring devices for capturing video screens of a to-be-monitored area and generating a plurality of image signals;
receiving the image signals of the monitoring devices by a central control device and aggregating the image signals thereof by an operational simulation unit; and
the central control device storing at least one location data and at least one geographic data, and the operational simulation unit first compressing the location data and the geographic data and then analyzing the compressed location data and the compressed geographic data with the aggregated image signals and generating at least one 3D simulation image; wherein
the central control device further has at least one display unit which can display the 3D simulation image and at least one manipulation unit which can control a presented angle orientation and a presentation distance of the 3D simulation image.

7. The 3D visual intelligent simulation display method as claimed in claim 6, wherein the operational simulation unit first automatically stitches overlapping parts of the images and then aggregates the image signals thereof.

8. The 3D visual intelligent simulation display method as claimed in claim 6, wherein the central control device is electrically connected to a global positioning system (GPS) and receives at least one of location data of the global positioning system, and the central control device is also electrically connected to a geographic information system (GIS) and receives at least one of geographic data of the geographic information system.

9. (canceled)

10. The 3D visual intelligent simulation display method as claimed in claim 9, wherein the central control device further stores at least one indoor map data, and the operational simulation unit first compresses the location data, the geographic data and the indoor map data, and then analyzes the compressed location data and the compressed geographic data, and the compressed indoor map data with the aggregated image signals and generates the 3D simulation image to be displayed by the display unit.
